(19) United States
(12) Patent Application Publication
(10) Pub. No.: US 2024/0257491 A1
(43) Pub. Date: Aug. 1, 2024

(54) FAST COMPUTATION OF RFD-LIKE DESCRIPTORS IN FOUR ORIENTATIONS

(71) Applicant: SMART ENGINES SERVICE, LLC, Moscow (RU)

(72) Inventors: Anton Vsevolodovich TRUSOV, Moscow (RU); Elena Evgenyevna LIMONOVA, Moscow (RU); Vladimir Viktorovich ARLAZAROV, Moscow (RU)

(21) Appl. No.: 18/409,675

(22) Filed: Jan. 10, 2024

(30) Foreign Application Priority Data
Jan. 30, 2023 (RU) 2023101901

(51) Int. Cl. G06V 10/44; G06V 10/28; G06V 10/34

(52) U.S. Cl. CPC G06V 10/443; G06V 10/28; G06V 10/34

(57) ABSTRACT

The computation of local feature descriptors for image matching in computer vision can be computationally expensive for real-time on-device applications. Accordingly, disclosed embodiments speed up such computations by precomputing values for gradient maps, and storing them in lookup tables indexed by partial derivatives. In addition, certain embodiments introduce global smoothing, and optionally, global gradient maps. In an embodiment that eliminates all floating-point operations, arctangents can be precomputed for a fixed number of angles, and quantization can be performed when computing the local feature descriptors.

### CROSS-REFERENCE TO RELATED APPLICATIONS

The present application claims priority to Russian Application No. 2023101901, filed on Jan. 30, 2023, which is hereby incorporated herein by reference as if set forth in full.

### BACKGROUND

### Field of the Invention

The embodiments described herein are generally directed to the localization and classification of identity documents, and, more particularly, to the fast computation of local feature descriptors in, for example, image-matching tasks.

### Description of the Related Art

In computer vision, local feature descriptors are compact vector representations of patches (i.e., small regions) of an image. For similar patches, the distance between their respective descriptors should be small. Conversely, for dissimilar patches, the distance between their respective descriptors should be large.

Local feature descriptors are widely used in image-matching algorithms, which aim to align two or more images of a scene or object, captured from different viewpoints, or to compare an input image to a reference. Image-matching algorithms are used in structure-from-motion (SfM) and multi-view-stereo (MVS) estimations (see Ref1), object tracking (see Ref2), localization of identity documents (see Ref3, Ref4), and many other practical tasks. Image matching that utilizes local feature descriptors is often referred to as “feature-based image matching” (see Ref5).

One of the most well-known algorithms for computing local feature descriptors is the Scale Invariant Feature Transform (SIFT) (see Ref6). SIFT computes orientation histograms of weighted gradients in four regions around the center of a patch, stores the computed orientation histograms in a vector, normalizes this vector, and uses the normalized vector as a local feature descriptor. Ref7 proposed Speeded-Up Robust Features (SURF) as a more computationally efficient local feature descriptor. SURF uses histograms of Haar wavelet responses, instead of orientation histograms of weighted gradients. Other algorithms for computing local feature descriptors include Local Binary Patterns (LBP) (see Ref8), DAISY (see Ref9), and Local Intensity Order Pattern (LIOP) (see Ref10).

SIFT, SURF, LBP, DAISY, LIOP, and other algorithms produce real-valued vectors. The similarity between local feature descriptors may be measured by the l₂ norm. However, the l₂ norm is computationally expensive. To reduce the computational expense of comparing local feature descriptors, binary descriptors have been proposed. Examples of binary descriptors include Binary Robust Independent Elementary Features (BRIEF) (see Ref11), and Oriented Features from Accelerated Segment Test (FAST) and Rotated BRIEF (ORB) (see Ref12), which represents a rotation-invariant modification to BRIEF. A significant advantage of binary descriptors is that the distance between descriptors is a Hamming distance, which is easy to compute. Hamming distances also allow for fast descriptor matching using multi-index hashing (see Ref13).

All of the local feature descriptors described above are hand-crafted (i.e., based on expertise in the field of image matching), as opposed to learning-based (see Ref14). Learning-based descriptor algorithms are constructed using a training set of patches (e.g., labeled pairs of matching and/or mismatching patches). These learning-based descriptor algorithms range from simple, such as the Principal Component Analysis Scale Invariant Feature Transform (PCA-SIFT) (see Ref15), to complex, deep-learning-based algorithms, such as TFeat (see Ref16) and Harmonic DenseNet (HarDNet) (see Ref17), which utilize convolutional neural networks. However, neural networks require long computation times, and therefore, are not appropriate for real-time on-device applications (e.g., on a smartphone, tablet computer, or other lightweight device).

Consequently, there has been significant interest in binary learning-based descriptors. Binary learning-based descriptor algorithms include boosted gradient maps (BGM) (see Ref18), BinBoost (see Ref19), and receptive field descriptors (RFD) (see Ref20). These algorithms combine the speed of binary vector matching with the quality of learning-based descriptors.

Recently, Ref21 proposed the RFDoc descriptor algorithm. RFDoc is very similar to classic RFD, and demonstrates state-of-the-art results in localizing and classifying identity documents in images. RFDoc exhibits high accuracy in identity-document localization and classification, and has the potential for fast feature-matching. In addition, the inference task is suitable for real-time on-device computations.

However, the inventors have recognized that the speed of computations in the RFDoc descriptor algorithm can be improved.

### SUMMARY

Accordingly, systems, methods, and non-transitory computer-readable media are disclosed for fast computation of local feature descriptors in, for example, image-matching tasks.

In an embodiment, a method comprises using at least one hardware processor to: precompute all possible integer values of partial derivatives of image pixels in an input image, the image pixels having a predetermined bit depth; for each of the precomputed integer values of partial derivatives, precompute integer values of gradient maps for at least a portion of the input image, and store the precomputed integer values of gradient maps in one or more lookup tables, indexed by the precomputed integer values of partial derivatives; compute local feature descriptors for a plurality of keypoints on the input image by computing the partial derivatives of the image pixels from the input image, determining gradient maps for each of the plurality of keypoints by performing lookups in the one or more lookup tables using the computed partial derivatives as an index without directly computing the gradient maps from the computed partial derivatives, and generating the local feature descriptor for each of the plurality of keypoints based on the gradient maps; and output an image descriptor of the input image, wherein the image descriptor comprises the computed local feature descriptors for the plurality of keypoints.

Computing the local feature descriptors may comprise, for each of the plurality of keypoints: extracting an image patch from the input image, wherein the image patch encompasses the keypoint; smoothing the image patch; and computing the partial derivatives of the image pixels from the smoothed image patch. The input image may comprise a scale pyramid comprising an image at a plurality of scales, wherein extracting an image patch comprises extracting an image patch from the image in the scale pyramid that is at one of the plurality of scales that corresponds to a scale of the keypoint. Smoothing the image patch may comprise applying a Gaussian filter to the image patch.

The method may further comprise using the at least one hardware processor to smooth the input image prior to computing the local feature descriptors, wherein computing the local feature descriptors comprises, for each of the plurality of keypoints: extracting an image patch, corresponding to the keypoint, from the smoothed input image; and computing the partial derivatives of the image pixels from the image patch. The input image may comprise a scale pyramid comprising an image at a plurality of scales, wherein extracting an image patch comprises extracting an image patch from the image in the scale pyramid that is at one of the plurality of scales that corresponds to a scale of the keypoint. Smoothing the input image may comprise applying a Gaussian filter to the input image.

The at least a portion of the input image may be an entirety of the input image. Alternatively, the at least a portion of the input image may consist of only regions of the input image that correspond to image patches for the plurality of keypoints.

The gradient maps may be determined according to

$$ϕ = \frac{4 ( Θ ( x , y ) + π )}{π}$$

$${w}_{1} = ϕ - ⌊ ϕ ⌋$$

$${n}_{0} = ⌊ ϕ ⌋ mod 8$$

$${n}_{1} = ( {n}_{0} + 1 ) mod 8$$

$${F}_{{n}_{1}} ( x , y ) = [ {w}_{1} M ( x , y ) ]$$

$${F}_{{n}_{0}} ( x , y ) = M ( x , y ) - {F}_{{n}_{1}} ( x , y )$$

$${F}_{i ; i ∈ \{ 0 , … , 7 \} ∖ \{ {n}_{0} , {n}_{1} \}} = 0$$

wherein x, y are coordinates in the input image, Θ is a gradient orientation, M is a gradient magnitude that is a function of the partial derivatives, └·┘ denotes rounding down, and [·] denotes rounding to the nearest integer, wherein the precomputed integer values of the gradient maps comprise n₀, n₁, Fₙ_{₀}, and Fₙ_{₁}, and wherein, during computation of the local feature descriptors, determining the gradient maps comprises looking up these precomputed integer values of the gradient maps in the one or more lookup tables. The method may further comprise using the at least one hardware processor to: prior to computing the local feature descriptors, precompute values of arctangent for a predetermined number of fixed angles based on the partial derivatives, and store the precomputed values of arctangent in the one or more lookup tables; wherein, during computation of the local feature descriptors, determining the gradient maps comprises quantizing a gradient into one of the fixed angles, and looking up the precomputed value of arctangent for that one fixed angle.

Generating the local feature descriptor may comprise, for each of the plurality of keypoints: extracting an image patch corresponding to the keypoint; and, for each of a plurality of rectangular receptive fields in the image patch, determine a response based on the gradient maps for the keypoint. Generating the local feature descriptor may comprise, for each of the plurality of keypoints, for each of the plurality of rectangular receptive fields in the image patch: binarize the response to produce a binary value; and store the binary value in a vector representing the local feature descriptor. Determining a response based on the gradient maps for the keypoint may comprise determining the response in each of four orientations by rotating the rectangular receptive field three times by 90 degrees, according to:

$${c}_{1} = ( {c}_{0} + 2 ) mod 8$$

$${x}_{1} = s - ( {h}_{0} + {y}_{0} )$$

$${y}_{1} = {x}_{0}$$

$${w}_{1} = {h}_{0}$$

$${h}_{1} = {w}_{0}$$

wherein x₀, y₀ represent a corner of the rectangular receptive field in a first orientation, w₀ represents a width of the rectangular receptive field in the first orientation, h₀ represents a height of the rectangular receptive field in the first orientation, c₀ represents an index of a gradient map for the first orientation, x₁, y₁ represent a corner of the rectangular receptive field in a second orientation rotated 90 degrees from the first orientation, w₁ represents a width of the rectangular receptive field in the second orientation, h₁ represents a height of the rectangular receptive field in the second orientation, and c₁ represents an index of a gradient map for the second orientation.

Generating the local feature descriptor may comprise, for each of the plurality of keypoints: extracting an image patch corresponding to the keypoint; and, for each of a plurality of rectangular receptive fields in the image patch, simultaneously determine a response and binarize the response to produce a binary value b, based on the gradient maps for the keypoint according to

$$b = \{ \begin{matrix}0 , & {\sum }_{x , y ∈ R} {F}_{c} ( x , y ) < t {\sum }_{x , y ∈ R} M ( x , y ) \\ 1 , & otherwise\end{matrix}$$

wherein x, y are coordinates in the image patch, R is a rectangle of the rectangular receptive field, F_{c} is a gradient map of the receptive field at index c, t is a threshold associated with the receptive field, and M is a gradient magnitude, and store the binary value b in a vector representing the local feature descriptor. The gradient magnitude M may be calculated as an l₁ norm. Alternatively, the gradient magnitude M may be calculated as an l₂ norm.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein, may be executed, according to an embodiment;

FIG. 2 illustrates a process for computing one or more RFD-like descriptors for an input image, according to an embodiment;

FIG. 3 illustrates a process for computing one or more RFD-like descriptors for an input image, using global smoothing, according to an embodiment;

FIG. 4 illustrates a process for computing one or more RFD-like descriptors for an input image, using global smoothing and global gradient maps, according to an embodiment;

FIG. 5 illustrates the indexing of points for arctangent precomputation, according to an embodiment; and

FIG. 6 illustrates the equivalence of rotating an image patch and rotating a receptive field, according to an embodiment.

### DETAILED DESCRIPTION

In an embodiment, systems, methods, and non-transitory computer-readable media are disclosed for fast computation of local feature descriptors in, for example, image-matching tasks. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

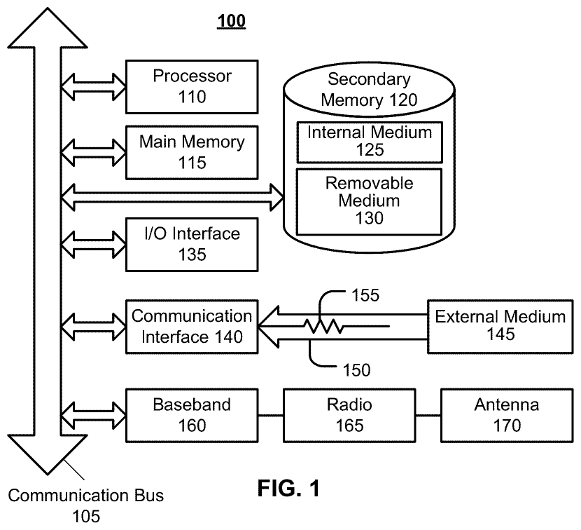

FIG. 1 is a block diagram illustrating an example wired or wireless system 100 that may be used in connection with various embodiments described herein. For example, system 100 may be used as or in conjunction with one or more of the functions, processes, or methods (e.g., to store and/or execute one or more software modules) described herein. System 100 can be a server, personal computer, or any other processor-enabled device that is capable of wired or wireless data communication. However, it is generally contemplated that system 100 would be a handheld device with limited computational resources (e.g., lightweight processor, battery-powered, etc.), such as a smartphone, tablet computer, or the like. Other computer systems and/or architectures may be also used, as will be clear to those skilled in the art.

System 100 preferably includes one or more processors 110. Processor(s) 110 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor that is subordinate to the main processing system), an additional microprocessor or controller for dual or multiple processor systems, and/or a coprocessor. Such auxiliary processors may be discrete processors or may be integrated with processor 110. Examples of processors which may be used with system 100 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 110 is preferably connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 100 preferably includes a main memory 115 and may also include a secondary memory 120. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Python, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 120 is a non-transitory computer-readable medium having computer-executable code (e.g., any of the software disclosed herein) and/or other data stored thereon. The computer software or data stored on secondary memory 120 is read into main memory 115 for execution by processor 110. Secondary memory 120 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 120 may optionally include an internal medium 125 and/or a removable medium 130. Removable medium 130 is read from and/or written to in any well-known manner. Removable storage medium 130 may be, for example, a magnetic tape drive, a compact disc (CD) drive, a digital versatile disc (DVD) drive, other optical drive, a flash memory drive, and/or the like.

In alternative embodiments, secondary memory 120 may include other similar means for allowing computer programs or other data or instructions to be loaded into system 100. Such means may include, for example, a communication interface 140, which allows software and data to be transferred from external storage medium 145 to system 100. Examples of external storage medium 145 include an external hard disk drive, an external optical drive, an external magneto-optical drive, and/or the like.

As mentioned above, system 100 may include a communication interface 140. Communication interface 140 allows software and data to be transferred between system 100 and external devices (e.g. printers), networks, or other information sources. For example, computer software or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 140 are generally in the form of electrical communication signals 155. These signals 155 may be provided to communication interface 140 via a communication channel 150. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 115 and/or secondary memory 120. Computer-executable code can also be received via communication interface 140 and stored in main memory 115 and/or secondary memory 120. Such computer-executable code, when executed, enable system 100 to perform the various functions of the disclosed embodiments as described elsewhere herein.

In this description, the term “computer-readable medium” is used to refer to any non-transitory computer-readable storage media used to provide computer-executable code and/or other data to or within system 100. Examples of such media include main memory 115, secondary memory 120 (including internal memory 125 and/or removable medium 130), external storage medium 145, and any peripheral device communicatively coupled with communication interface 140 (including a network information server or other network device). These non-transitory computer-readable media are means for providing software and/or other data to system 100.

In an embodiment that is implemented using software, the software may be stored on a computer-readable medium and loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more of the processes and functions described elsewhere herein.

In an embodiment, I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 100 may also include optional wireless communication components that facilitate wireless communication over a voice network and/or a data network (e.g., in the case of a mobile device, such as a smart phone). The wireless communication components comprise an antenna system 170, a radio system 165, and a baseband system 160. In system 100, radio frequency (RF) signals are transmitted and received over the air by antenna system 170 under the management of radio system 165.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is also communicatively coupled with processor(s) 110. Processor(s) 110 may have access to data storage areas 115 and 120. Processor(s) 110 are preferably configured to execute instructions (i.e., computer programs, such as the disclosed software) that can be stored in main memory 115 or secondary memory 120. Computer programs can also be received from baseband processor 160 and stored in main memory 110 or in secondary memory 120, or executed upon receipt. Such computer programs, when executed, can enable system 100 to perform the various functions of the disclosed embodiments.

### 2. Process Overview

Embodiments of processes for fast computation of local feature descriptors (e.g., in image-matching tasks) will now be described in detail. It should be understood that the described processes may be embodied in one or more software modules that are executed by one or more hardware processors (e.g., processor 110), for example, as a computer program or software package. The described processes may be implemented as instructions represented in source code, object code, and/or machine code. These instructions may be executed directly by hardware processor(s) 110, or alternatively, may be executed by a virtual machine operating between the object code and hardware processor(s) 110.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. Introduction

Developers have always strived to increase the computational efficiency of computing local feature descriptors, while preserving the quality of the resulting descriptors. For example, SIFT uses a scale pyramid to provide scale invariance to its detector-descriptor pair. The scale pyramid (see Ref23) is a data structure that is widely used in the fields of image processing and computer graphics. The scale pyramid consists of the input image and down-scaled copies of the input image. However, a significant amount of time is required to compute and process a scale pyramid.

Thus, SURF was proposed. SURF uses a scale-invariant detector that is based on a box filter, and a descriptor that is based on Haar wavelet responses. The box filter and Haar wavelets require sums over rectangular image regions. Such sums can be computed very quickly with the help of an integral image (see Ref24). An integral image is a two-dimensional generalization of the prefix sum. Integral images are also used in RFD and RFDoc descriptors to compute sums over rectangular pooling regions, and in covariance-based descriptors (see Ref25) for fast covariance computation.

As demonstrated by SIFT and SURF, specific data structures may be useful for fast computation of local feature descriptors. A lookup table (LUT) is another such data structure. A lookup table is an array of precomputed values that are used to replace complex computations with a simple indexing operation. A classic example of the application of lookup tables is the method of Four Russians (see Ref26). Lookup tables can also be useful in computing descriptors. For example, lookup tables are used to accelerate computations in Compact and Real-time Descriptors (CARD) (see Ref27) and Zernike moments-based descriptors (see Ref28).

There is always a trade-off between computational efficiency and the quality of the results. For example, one of the fastest descriptors is BRIEF. However, BRIEF is not robust, even against small rotations. ORB fixed this drawback of BRIEF. ORB combines the BRIEF descriptor with the FAST keypoint detector (see Ref29), which compensates the rotation. ORB works very fast, especially when modified for the Single Instruction Multiple Data (SIMD) architecture, which is supported by most modern CPUs (see Ref30). However, the quality of ORB is significantly less than other binary descriptors, such as Boosted Efficient Binary Local Image Descriptor (BEBLID) (see Ref31) and RFDoc, which are only slightly more computationally complex than ORB.

The highest quality results are usually demonstrated by deep-learning algorithms, such as HarDNet and local Descriptors Optimized for Average Precision (DOAP) (see Ref32). Unfortunately, deep-learning algorithms have much higher computational requirements. Quantization, which replaces floating-point operations with integer operations (see Ref33), can improve the speed of such algorithms. However, even with such improvements, deep-learning algorithms are unlikely to be suitable for real-time, on-device applications.

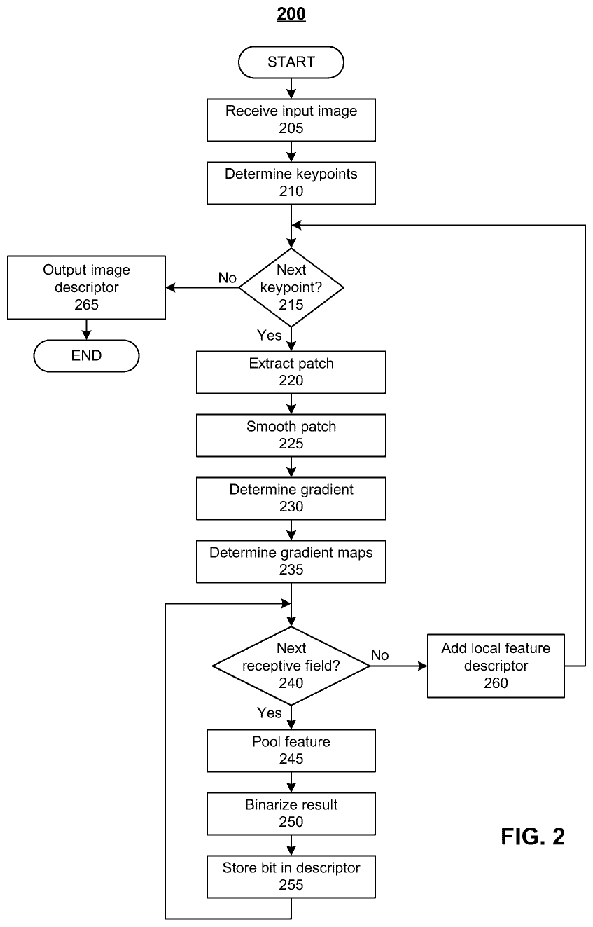

FIG. 2 illustrates a process 200 for computing one or more RFD-like descriptors for an input image, according to an embodiment. The purpose of process 200 is to, for each keypoint k on an input image I, describe the areas around that keypoint k as a binary vector of fixed length n. Process 200 may be governed by one or more hyperparameters, which will be described with respect to various subprocesses disclosed herein.

### 2.2. Baseline Image Descriptor Computation

It should be understood that process 200 may be executed for each image, to be matched in an image-matching algorithm, to produce a set of local feature descriptors that represents an image descriptor for that image. It should be understood that the image descriptors for two images may be compared to each other, according to some similarity or distance metric, to determine whether or not the two images match each other. In one contemplated application, each image is an image of an identity document to be localized and classified. However, it should be understood that process 200 could be applied to images of other objects, including other types of documents.

In subprocess 205, an input image I is received. Although not illustrated, input image I may be preprocessed, which may include converting input image I to grayscale, cropping input image I, correcting distortion in input image I, and/or the like.

In subprocess 210, a plurality of keypoints k are determined on input image I. Keypoints k may be determined using any known technique. In the subsequent subprocesses, process 200 will iteratively process each keypoint k in an outer loop, defined by subprocesses 215-260. The iterations of the outer loop may all be performed serially, or two or more, and potentially all, of the iterations of the outer loop may be performed in parallel.

In subprocess 215, it is determined whether or not another keypoint k remains to be processed. If another keypoint k remains to be processed (i.e., “Yes” in subprocess 215), process 200 proceeds to subprocess 210 to perform an iteration of the outer loop for that keypoint k. The inputs to the iteration of the outer loop may comprise input image I, the coordinates of the keypoint k on input image I, a list of coordinates of n pooling regions or receptive fields γ₁, γ₂, . . . , γₙ, and a list of n thresholds t₁, t₂, . . . , tₙ. On the other hand, if all keypoints k have been processed (i.e., “No” in subprocess 215), process 200 proceeds to subprocess 265 and then ends.

In subprocess 220, an image patch is extracted from input image I, based on the inputs to the iteration of the outer loop. The image patch may be a region around the coordinates of keypoint k. The image patch may have a size s×s, in which s is a hyperparameter of process 200 that defines a fixed patch size.

In subprocess 225, the image patch, which was extracted in subprocess 220, is smoothed or blurred to reduce noise. The image patch may be smoothed according to a hyperparameter σ of process 200. Smoothing may be performed using any known technique.

In subprocess 230, the discrete gradient for each pixel of the smoothed image patch, output by subprocess 225, is determined. For example, the gradients may be computed using any known technique.

In subprocess 235, the discrete gradient of each pixel of the smoothed image patch, as determined in subprocess 230, is mapped into eight images, according to the orientation of the gradient. In particular, the magnitude of the discrete gradient for each pixel may be mapped by bilinear soft assignment to the two nearest ones of the eight bins with orientations of 0, π/4, π/2, 3π/4, π, 5π/4, 3π/2, and 7π/4 radians. The computation of these gradient maps may be performed using any known techniques.

In the subsequent subprocesses, process 200 will iteratively process each receptive field γ₁, γ₂, . . . , γₙ in an inner loop, defined by subprocesses 240-255. The iterations of the inner loop may all be performed serially, or two or more, and potentially all, of the iterations of the inner loop may be performed in parallel. For the inner loop, a counter may be initialized to zero (or one) and incremented after each iteration of the inner loop, until (or after) the counter reaches n. In any case, an iteration of the inner loop is performed for each receptive field γ. It should be understood that n iterations of the inner loop will be performed during each iteration of the outer loop.

In subprocess 240, it is determined whether or not another receptive field γ remains to be considered. It may be determined that another receptive field γ remains to be considered when less than n iterations have been performed or upon some other indication that at least one receptive field γ has not yet been considered during an iteration of the inner loop. When determining that another receptive field γ remains to be considered (i.e., “Yes” in subprocess 240), process 200 proceeds to subprocess 245. Otherwise, when determining that no receptive fields γ remain to be considered (i.e., “No” in subprocess 240), process 200 proceeds to subprocess 260.

In subprocess 245, a feature is pooled for the next receptive field γ to be considered. For example, if a counter i is used as an index into the list of coordinates for receptive fields γ₁, γ₂, . . . , γₙ, the coordinates for the receptive field γ; are used for the feature pooling. In feature pooling for receptive field γᵢ, the values of one or more of the gradient maps, computed in subprocess 235, are integrated over receptive field γᵢ. The result of this integration is referred to as a “response” over receptive field γᵢ. This response may be normalized by the sum of corresponding responses over all receptive fields γ₁, γ₂, . . . , γₙ.

In subprocess 250, the result of subprocess 245 (i.e., the response over current receptive field γᵢ) is binarized using the corresponding threshold from the list of thresholds t₁, t₂, . . . , tₙ. For example, if the counter i is used, the threshold tᵢ is used in subprocess 250. Embodiments of binarization are described in Ref20 and Ref21. The output of subprocess 250 is a single bit representing the resulting binary value.

In subprocess 255, the bit, output by subprocess 250, is stored in a corresponding position in a vector representing the descriptor for keypoint k. For example, if a counter i is used, the bit will be stored at position i in the vector. It should be understood that the vector is n bits in length, and that, over n iterations of the inner loop, a bit will be stored in each position in the n-bit vector.

In subprocess 260, the n-bit vector is added, as a local feature descriptor of keypoint k, to an image descriptor of input image I. It should be understood that the image descriptor comprises all of the local feature descriptors that are added in iterations of the inner loop. Whereas the local feature descriptor describes the image patch that was extracted in subprocess 220, the image descriptor describes the entire input image I.

In subprocess 265, the image descriptor, produced over all iterations of the inner loop, is output as the image descriptor of input image I. The output image descriptor for input image I can be compared to the image descriptor of another image or a reference image descriptor to estimate the similarity of keypoints in two different images, for example, within an overarching image-matching algorithm. It should be understood that the image-matching algorithm may itself be part of a larger algorithm, such as a software module or application that localizes and classifies identity documents in images.

As illustrated above, process 200 is a complex process that comprises several subprocesses or stages. The speed of process 200 will greatly depend on the implementation of each subprocess. Accordingly, specific implementations of these subprocesses, as well as modifications to process 200, are described herein. It should be understood that embodiments of process 200 may comprise the implementation for a single one of the subprocesses and/or modifications described herein, the implementations for all of the subprocesses and/or modifications described herein, or the implementations for any subset of the subprocesses and/or modifications described herein. Thus, the fact that a particular implementation of a subprocess or modification to process 200 is described herein does not mean that every embodiment must utilize that implementation or modification.

An implementation of the extraction of an image patch in subprocess 220 will now be described in detail, according to an embodiment. In subprocess 220, a rectangular image patch of fixed size s×s is extracted around the current keypoint k from subprocess 215.

### 2.3. Patch Extraction

The keypoints may be selected by a keypoint-extraction algorithm in subprocess 210. Subprocess 220 may receive the coordinates (xₚ, yₚ) of the keypoint k within input image I, along with the scale sₚ and the orientation θ. The scale sₚ determines the up-scale or down-scale rate for the area around keypoint k. The orientation θ determines the rotation of the image patch (see Ref6, Ref7).

Each keypoint k may also have a score. The score of a keypoint k is a value that represents the keypoint-extraction algorithm's confidence that the coordinates (xₚ, yₚ) do indeed represent a keypoint (see Ref34). The score may be used to limit the maximum number of keypoints to be processed if too many keypoints were detected on the input image I. For example, only a predefined number of keypoints with the highest scores may be retained and processed by the outer loop, defined by subprocesses 215-260.

Given the coordinates (xₚ, yₚ), the scale sₚ, and the orientation θ of the keypoint k, the coordinates (u, v) of the image patch are mapped to the coordinates (x, y) of input image I via an affine transformation, which is a combination of scale transformation, rotation, and translation:

$$\begin{matrix}x = {s}_{p} ( ( u - \frac{s}{2} ) cos θ - ( v - \frac{s}{2} ) sin θ ) + {x}_{p} \\ y = {s}_{p} ( ( u - \frac{s}{2} ) sin θ - ( v - \frac{s}{2} ) cos θ ) + {y}_{p}\end{matrix} \qquad Scheme ( 1 )$$

Calculating the affine transformation in Scheme (1) for each pixel of the image patch is computationally demanding. However, if sₚ=1 and θ=0, Scheme (1) simplifies to:

$$\begin{matrix}x = u - \frac{s}{2} + {x}_{p} \\ y = v - \frac{s}{2} + {y}_{p}\end{matrix} \qquad Scheme ( 2 )$$

In this case, a region of input image I is simply copied. Since there is no additional computation, Scheme (2) works significantly faster than Scheme (1).

In an embodiment, Scheme (2) is used, instead of Scheme (1). To use a unit scale sₚ=1, a scale pyramid can be applied, as in Ref23. The scale pyramid can be constructed before the keypoint extraction and reused for every iteration of the outer loop that is executed on the keypoints k that were determined in subprocess 210. For each keypoint k, the nearest layer of the scale pyramid, in terms of sₚ, is selected, and the image patch is copied from the selected layer of the scale pyramid. To account for keypoint orientations and to set θ=0, keypoints k without orientations are used. For example, prior to execution of the outer loop, the global rotation of input image I is estimated based on straight line segments (e.g., using the method described in Ref3), and the estimated global rotation of input image I is compensated. In this manner, orientation-less feature-based matching (e.g., of an image of an input document to a document template) can be performed.

In summary, an embodiment may have one or more, including potentially all, of the following characteristics: a scale pyramid (e.g., 8-bit single-channel image pyramid) is constructed as input image I; keypoints k do not have orientations (i.e., θ=0); and/or keypoint scales sₚ specify the layer of the scale pyramid to be used for patch extraction. It may be assumed herein that the input images are 8-bit single-channel images, since this is one of the most widely used formats in practical applications. However, the disclosed embodiments may be applied to other image formats, with appropriate modifications to intermediate data types to prevent overflows. It should be understood that, in an embodiment, the layer of the scale pyramid that is selected for patch extraction is used as the image from which the patch is extracted in subprocess 220. In an embodiment that has all three of the above characteristics, patch extraction in subprocess 220 is a simple copy of an s×s region from input image I (e.g., from the layer of the scale pyramid that matches the scale sₚ of the respective keypoint k).

### 2.4 Patch Smoothing

Since RFD relies on the directions of gradients, any noise in the image patch that was extracted in subprocess 220 may cause significant errors in the values of the partial derivatives. Thus, in an embodiment, patch smoothing is performed in subprocess 225, prior to the gradient computation in subprocess 230. Smoothing or “blur” reduces the impact of noise on the computed gradient.

An alternative way to estimate the gradient of the image patch with lower noise-caused errors is to use a Sobel operator, derivative-of-Gaussian operator, or similar operator. However, this would require two convolutions with such filters for both the horizontal and vertical partial derivatives. In terms of efficiency, it is better to compute a single convolution with a separable blurring filter (e.g., Gaussian filter), and then use a simple difference scheme twice to find partial derivatives (see Ref35).

In an embodiment, the smoothing in subprocess 225 is performed by a Gaussian filter. The parameter σ of the Gaussian filter may be a hyperparameter of process 200. The output of this Gaussian filter is an image with the same bit depth (e.g., eight bits) as the image patch.

An implementation of the computation of gradients in subprocess 230 will now be described in detail, according to an embodiment. Subprocess 230 takes the smoothed image patch, output by subprocess 225, and computes the vertical and horizontal partial derivatives as the gradient. This can be done using a simple-difference scheme:

### 2.5. Gradient Computation

$$\frac{\partial }{\partial n} f ( n ) = ( f ( n + 1 ) - f ( n - 1 ) ) / 2 \qquad Scheme ( 3 )$$

wherein ƒ(n) is a function of a discrete argument n.

However, if Scheme (3) is directly applied to an image patch, represented by 8-bit integers, the result will either be a floating-point value or inaccurate (e.g., when integer division with rounding towards zero is used). The conversion to the floating-point data type is time-consuming and unnecessary. Instead, in an embodiment, the value of partial derivatives of integer patch P(x, y) is doubled:

$$\begin{matrix}\frac{\partial }{\partial x} P ( x , y ) \approx P ( x + 1 , y ) - P ( x - 1 , y ) \\ \frac{\partial }{\partial y} P ( x , y ) \approx P ( x , y + 1 ) - P ( x , y - 1 )\end{matrix} \qquad Scheme ( 4 )$$

Although the value of the gradient doubles, the orientation of the gradient is preserved. The orientation is what is essential for RFD-like descriptors.

Since the difference between two unsigned 8-bit integers may overflow the 8-bit integer data type, the result should be stored in a signed 16-bit integer data type. In an embodiment, in subprocess 230, the smoothed image patch is converted to a 16-bit data type, and then the partial derivatives are computed as the difference between two signed 16-bit integers, according to Scheme (4).

### 2.6. Gradient Maps Computation

Gradient maps are images from the image patch that represent the intensity of the gradient in a given direction. An implementation of the computation of gradient maps in subprocess 235 will now be described in detail, according to an embodiment. Given partial derivatives of the image patch, Pₓ(x, y) for the horizontal direction and P_{y}(x, y) for the vertical direction, the orientation Θ(x, y) is defined as:

$$Θ ( x , y ) = a tan 2 ( {P}_{x} ( x , y ) , {P}_{y} ( x , y ) ) \qquad Scheme ( 5 )$$

$$- π \leq a tan 2 ( x , y ) \leq π$$

wherein a tan 2(·) is a two-argument arctangent function. The function a tan 2(x, y) measures the angle between the (x, y) vector and the positive direction of the x-axis.

To compute the gradient maps, the magnitude of the gradient is required. In an embodiment, the magnitude (also known as intensity) M (x, y) of the gradient is calculated as the l₂ norm:

$$M ( x , y ) = \sqrt{{{P}_{x} ( x , y )}^{2} + {{P}_{y} ( x , y )}^{2}} \qquad Scheme ( 6 )$$

In an alternative embodiment, the magnitude of the gradient may be calculated as the l₁ norm:

$$M ( x , y ) = \vert {P}_{x} ( x , y ) \vert + \vert {P}_{y} ( x , y ) \vert \qquad Scheme ( 7 )$$

Use of the l₁ norm may make the descriptor more robust and faster to compute.

Given the orientation Θ(x, y) and the magnitude M(x, y), the eight gradient maps F₀(x, y), . . . , F₇(x, y) may be computed as follows:

$$ϕ = \frac{4 ( Θ ( x , y ) + π )}{π} \qquad Scheme ( 8 )$$

$${w}_{1} = ϕ - ⌊ ϕ ⌋$$

$${n}_{0} = ⌊ ϕ ⌋ mod 8$$

$${n}_{1} = ( {n}_{0} + 1 ) mod 8$$

$${F}_{{n}_{1}} ( x , y ) = [ {w}_{1} M ( x , y ) ]$$

$${F}_{{n}_{0}} ( x , y ) = M ( x , y ) - {F}_{{n}_{1}} ( x , y )$$

$${F}_{i ; i ∈ \{ 0 , … , 7 \} ∖ \{ {n}_{0} , {n}_{1} \}} = 0$$

wherein └·┘ denotes rounding down and [·] denotes rounding to the nearest integer. The above operation selects the two nearest orientation bins, Fₙ_{₀} and Fₙ_{₁}, for a given pixel, and then uses bilinear soft assignment to map the magnitude of the gradient to the given pixel.

The computation of gradient maps is a pixel-wise operation with integer inputs, Pₓ and P_{y}, and integer outputs, F₀, . . . , F₇(x, y). To prevent unnecessary memory allocation, the computation of the gradient maps in subprocess 235 may be implemented as a separate subprogram. Algorithm 1 below represents pseudocode for an embodiment of this subprogram. In Algorithm 1, norm denotes the vector norm, which may either be the l₁ or l₂ norm, floor denotes rounding down, and round denotes rounding to the nearest integer. In an embodiment, the gradient maps are unsigned 16-bit images. In addition, the magnitude of the gradient may be stored as an unsigned 16-bit image, to be used for feature pooling in subprocess 245 and binarization in subprocess 250.

Algorithm 1

```
Input:
    Pₓ, P_{y} - partial derivatives (gradient) of the image patch
    s x s signed 16-bit images
Output:
    F₀, ..., F₇ - eight gradient maps
    M - gradient magnitude
    s x s unsigned 16-bit images
for i from 0 to 7 do
    Fᵢ ← 0 // Zero initialize the output
end
M ← 0
q ← 4.0/n // sector size for one bucket
for y from 0 to s-1 do
    for x from 0 to s-1 do
        m ← norm (Pₓ(x,y), P_{y}(x,y) )
        if m>0 then
            Φ ← q* (atan2(Pₓ(x,y),P_{y}(x,y) ) + Π
          ψ ← floor (Φ)
            w₁ ← Φ − ψ
            n0 ← ψ mod 8
            n₁ ← (n₀+1) mod 8
            Fn₁(x,y) ← round (m * w₁)
            Fn₂(x,y) ← m − Fₙ₁(x,y)
        end
    end
end
```

### 2.7. Feature Pooling

An implementation of the feature pooling in subprocess 245 will now be described in detail, according to an embodiment. During feature pooling, the responses over receptive fields γ are computed. In an embodiment, the receptive fields γ are rectangular. Sums over rectangles can be efficiently computed with the help of an integral image (see Ref24). While Gaussian pooling regions could be used, experiments demonstrate that they do not produce descriptors with noticeably higher quality (see Ref20).

The position of a rectangular receptive field γ, representing a pooling region, may be determined by five integer variables (x₀, y₀, w, h, c), wherein (x₀, y₀) are the coordinates of the top-left corner of the rectangle, w is the width of the rectangle, h is the height of the rectangle, and c is the index of the gradient map (i.e., 0≤ c<8). The rectangle R(x₀, y₀, w, h) lies within the s×s image patch.

The response to the receptive field γ=(R(x₀, y₀, w, h), c), representing the pooling region, is:

$$g ( γ ) = \frac{{\sum }_{x , y ∈ R} {F}_{c} ( x , y )}{{\sum }_{i = 0}^{7} {\sum }_{x , y ∈ R} {F}_{c} ( x , y )} \qquad Scheme ( 9 )$$

wherein R denotes the rectangle defined by variables (x₀, y₀, w, h).

Consider an integral image S for image F:

$$S ( x , y ) = \{ \begin{matrix}{\sum }_{i = 0}^{y - 1} {\sum }_{j = 0}^{x - 1} F ( j , i ) , & x , y > 0 \\ 0 , & otherwise\end{matrix} \qquad Scheme ( 10 )$$

Integral image S can be easily computed dynamically, since

$$S ( x , y ) = S ( x - 1 , y ) + S ( x - 1 , y ) + F ( x - 1 , y - 1 )$$

for positive x and y. Integral image S has size (s+1)×(s+1), and allows for simple computation of sums over rectangles on F:

$${\sum }_{y = {y}_{0}}^{{y}_{1} - 1} {\sum }_{x = {x}_{0}}^{{x}_{1} - 1} F ( x , y ) = S ( {x}_{1} , {y}_{1} ) - S ( {x}_{0} , {y}_{1} ) - S ( {x}_{1} , {y}_{0} ) + S ( {x}_{0} , {y}_{0} ) \qquad Scheme ( 11 )$$

When gradient maps are constructed according to Scheme (8), for each pixel, the sum of all gradient maps is the magnitude of the gradient. Thus, Scheme (9) can be simplified:

$$g ( γ ) = \frac{{Σ}_{x , y ∈ R} {F}_{c} ( x , y )}{{Σ}_{x , y ∈ R} M ( x , y )} \qquad Scheme ( 12 )$$

All the sums in Scheme (12) can be computed using integral images for gradient maps and magnitude. In an embodiment, all of the sums in Scheme (12) are computed once per s×s image patch and stored in (s+1)×(s+1) unsigned 16-bit images.

### 2.8. Binarization

An implementation of the binarization in subprocess 245 will now be described in detail, according to an embodiment. In an embodiment, each receptive field γᵢ has a corresponding threshold tᵢ. The binarization determines the value of the i-th bit of the descriptor of the image patch that was extracted in subprocess 220:

$${b}_{i} = \{ \begin{matrix}0 , & g ( {γ}_{i} ) < {t}_{i} \\ 1 , & g ( {γ}_{i} ) \geq {t}_{i}\end{matrix} \qquad Scheme ( 13 )$$

To avoid time-consuming floating-point division, the response computation, using Scheme (12), can be combined with the binarization, using Scheme (13):

$${b}_{i} = \{ \begin{matrix}0 , & {\sum }_{x , y ∈ {R}_{i}} {F}_{{c}_{i}} ( x , y ) < {t}_{i} {\sum }_{x , y ∈ {R}_{i}} M ( x , y ) \\ 1 , & otherwise\end{matrix} \qquad Scheme ( 14 )$$

wherein Rᵢ is the rectangle of the receptive field γᵢ, and cᵢ is the index of the gradient map of the receptive field γᵢ.

In an embodiment, each bit of the descriptor for a given image patch is calculated by Scheme (14), using the integral images of the gradient maps and the magnitude of the gradient as inputs. The result is a binary RFD-like descriptor for an image patch (e.g., 8-bit single-channel image patch). This binary RFD-like descriptor is what is output as the local feature descriptor of the image patch in subprocess 260.

Notably, the receptive fields γ and the corresponding thresholds t are parameters of the RFD-like descriptor. They may be determined by training on a task-specific dataset (see Ref20, Ref21).

### 2.9. Baseline Algorithm

Algorithm 2 below represents pseudocode for a baseline embodiment of the outer loop in process 200.

Algorithm 2

```
Input:
    I − image or scale pyramid
    K − list of coordinates of keypoints on I
    σ − smoothing parameter for Gaussian blur
    γ − list of n receptive fields (i.e., pooling regions) for descriptor
    t − list of n thresholds, one for each receptive field in γ
Output:
    D − list of descriptors, one for each keypoint in K
for each keypoint in K do
    Select patch P according to k // extract patch [220]
    Pₛ ← GaussianBlur (P,σ) // smooth patch [225]
    P₁₆ ← Cast8_16(Pₛ) // convert patch to 16-bit image to avoid overflow
    Pₓ,P_{y} ← Gradient (P₁₆) // compute discrete gradient as 2 16-bit images [230]
    F₀,...,F₇,M ← GradientMap (Pₓ,P_{y}) // compute gradient maps and magnitude [235]
    for i from 0 to 7 do
        Sᵢ ← Integrate (Fᵢ)
    end
    S ← Integrate (M)
    d ← 0 // set up empty n-bit descriptor [255]
    for j=0; j<n; j←j+1 do
        f ← Sum(Sᵢ,R) // compute response over yⱼ;=(R,i) [245]
        m ← Sum(S,R) // compute response over M
        if f>m*tⱼ then // [250]
            dⱼ ← 1 // [255]
        end
    end
    Pass d to D as a descriptor for k [260]
end
```

Table 1 below represents the data flow in an implementation of Algorithm 2, from the s×s unsigned 8-bit image patch to the n-bit descriptor. In this implementation, all of the data are stored in 8-bit or 16-bit integers. As a result, Algorithm 2 is memory-efficient.

TABLE 1

| | | Image | # of | |
|---|---|---|---|---|
| # | Data | Size | Images | Data Type |
| 0 | Input patch | s × s | 1 | unsigned 8-bit integer |
| 1 | Smoothed patch | s × s | 1 | unsigned 8-bit integer |
| 2 | 16-bit patch | s × s | 1 | 16-bit integer |
| 3 | Partial derivatives | s × s | 2 | 16-bit integer |
| 4 | Gradient maps & | s × s | 9 | unsigned 16-bit integer |
| | Magnitude | | | |
| 5 | Integral images | (s + 1) × | 9 | unsigned 16-bit integer |
| | | (s + 1) | | |
| 6 | Descriptor | n | 1 | Boolean |

However, in Algorithm 2, there are still time-consuming floating-point operations during the computation of gradient maps in subprocess 235. In addition, this implementation processes all image patches separately, and does not take into account that, in the image-matching task, all of the image patches are extracted from the same image.

To address these drawbacks, embodiments may utilize one or more of the following modifications to the baseline in Algorithm 2. As mentioned above, Algorithm 2 has two weak points: (i) it requires many computationally expensive operations (e.g., a tan 2(·) in the computation of gradient orientation); and (ii) it processes each image patch separately. Although point (ii) may not seem like a drawback, if there are many intersections between patches, there will be many redundant computations. In this case, it may be faster to perform a single operation over the entire image, than to do it over multiple patches in the image.

### 2.9.1. Global Smoothing (GS) Modification

In subprocess 225, the image patch is smoothed. This smoothing may be performed by convolution of the image patch with a Gaussian filter, as represented by GaussianBlur( ) in Algorithm 2. The Gaussian filter is separable, such that the convolution can be performed in two steps: (i) convolution with horizontal filters; and (ii) convolution with vertical filters. In this case, convolution is performed, consecutively, row-by-row over the input image.

In practice, the rows of an image are usually stored consecutively in memory. Thus, the separable convolution is a cache-friendly operation. CPU caching with preloading provides faster access to values from memory when those values are loaded consecutively. Thus, when the number of image patches is high, a single application of the Gaussian filter to the whole image may be faster than applications of the Gaussian filter to each of the image patches.

Accordingly, in an embodiment, Algorithm 2 is modified to apply global smoothing for the whole input image, instead of local smoothing for each image patch that is extracted from the input image. In other words, the Gaussian filter is applied to the entire input image I, prior to patch extraction in subprocess 220.

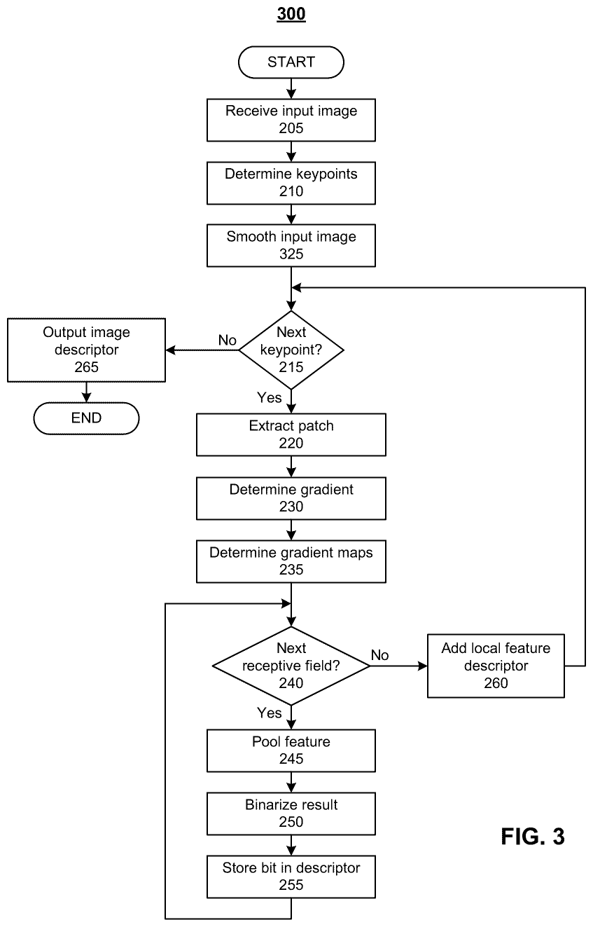

FIG. 3 illustrates a process 300 that employs an embodiment of this modification, which is referred to herein as the global smoothing (GS) modification. As illustrated, the patch-wise smoothing of subprocess 225 has been removed from the outer loop, defined by subprocesses 215-260. In addition, a new subprocess 325 has been added before the outer loop to smooth the entire input image I. It should be understood that, if input image I is a scale pyramid (e.g., for multi-scale keypoints), smoothing may be applied to all of the layers of the scale pyramid or applied to the original source image from which the scale pyramid is constructed.

Subprocess 325 may utilize the same smoothing technique as described above with respect to subprocess 225 (e.g., a Gaussian filter), but applied to the entire input image I, instead of to individual image patches. All of the remaining subprocesses in FIG. 3 may be identical to the identically numbered subprocesses described with respect to FIG. 2. Therefore, these subprocesses will not be redundantly described herein.

### 2.9.2. Global Gradient Maps and Magnitude (GM) Modification

In an embodiment, referred to herein as the global map (GM) modification, all of the gradient maps and the magnitude of the gradient are computed for the entire input image I. This will produce eight images for the gradient maps and one image for the magnitude. All of these images will have the same size as input image I. Patches may then be extracted from these images to perform feature pooling in subprocess 245 and binarization in subprocess 245.

The primary advantage of the GM modification is that it does not redundantly compute the same parts of the gradient maps within the intersections of the image patches. In addition, the GM modification can efficiently use CPU caches in the same manner as described above with respect to the GS modification. It should be understood that this GM modification can and should be used in combination with the GS modification.

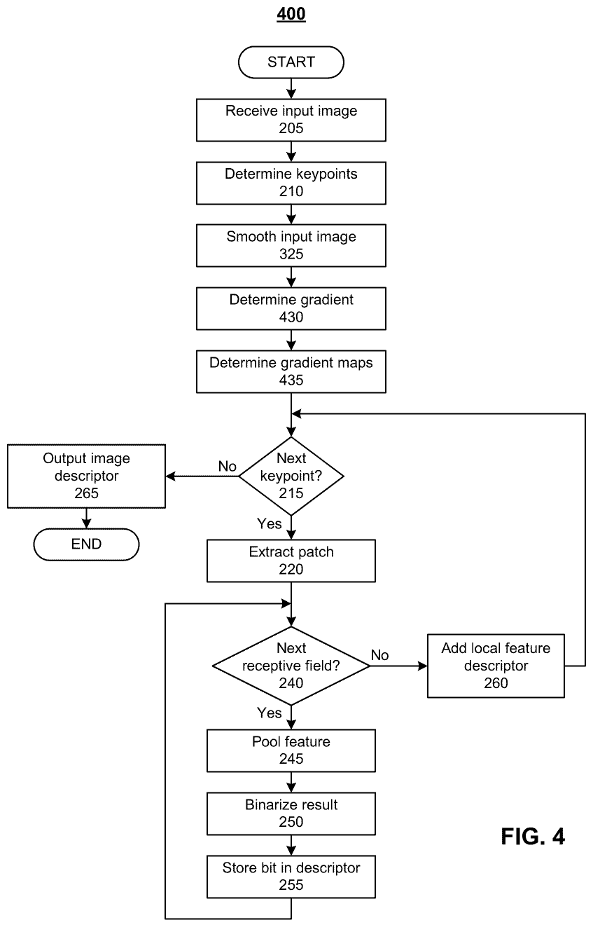

FIG. 4 illustrates a process 400 that employs an embodiment of both the GS and GM modifications. As illustrated, the patch-wise gradient computation in subprocess 230 and gradient-map computation in subprocess 235 have been removed from the outer loop, defined by subprocesses 215-260. In addition, new subprocesses 430 and 435 have been added before the outer loop to determine the gradient and gradient maps, respectively, for the entire input image I, after input image I has been smoothed in subprocess 325.

Subprocesses 430 and 435 may utilize the same schemes as described above with respect to subprocesses 230 and 235, respectively. All of the remaining subprocesses in FIG. 4 may be identical the identically numbered subprocesses described with respect to FIGS. 2 and 3. Therefore, these subprocesses will not be redundantly described herein.

A drawback of the GM modification, as applied to the entire input image I, is that it will compute portions of the gradient maps that fall outside of the image patches (i.e., portions of the computed gradient maps are not used in any subsequent computations). In an embodiment, to overcome this drawback, only the regions of the gradient maps that are encompassed by or otherwise correspond to at least one image patch are determined in subprocess 435. It should be understood that the gradient maps may still have the same size as the input image I, but will have un-computed regions. To accomplish this, in an embodiment of subprocess 435, regions corresponding to the image patches around keypoints k are processed sequentially, and overlapping regions are only determined once. However, for practical applications, parallel patch-wise processing is faster.

### 2.9.3. Full Precomputing (FP) Modification

As mentioned above, one of the primary drawbacks of Algorithm 2 is the use of time-consuming floating-point operations during the computation of the gradient maps. However, in Schemes (5)-(8), the values in the feature map for a given pixel are determined by the values of partial derivatives Pₓ, P_{y} of the pixel. According to Scheme (4), when the smoothed patch is an 8-bit image, the values of partial derivatives are integers in the range −255≤Pₓ, P_{y}≤255. Consequently, there are only 511 possible values for partial derivatives Pₓ, P_{y}.

In an embodiment, referred to herein as the full precomputing (FP) modification, lookup tables are used to accelerate computations in subprocesses 230-235 or 430-435. In particular, for all possible combinations of Pₓ and P_{y}, all possible values (e.g., 8-bit values) of no and n₁ and all possible values (e.g., 16-bit values) of Fₙ_{₀} and Fₙ_{₁} are computed, according to Scheme (8). These precomputed values are then stored into four 511×511 lookup tables. The partial derivatives Pₓ, P_{y} can be used as indices into these lookup tables. The four lookup tables consist of individual lookup tables for the pre-computed values of each of n₀, n₁, Fₙ_{₀}, and Fₙ_{₁}. However, it should be understood that the precomputed values could be stored in a different manner.

After the FP modification, the one remaining floating-point operation is multiplication by a threshold in Scheme (14). The most time-consuming operations, such as a tan 2(·) and square roots, are not required at all.

The only drawback of this FP modification is the size of the lookup tables. In particular, the number of bytes requires to represent the four lookup tables is 511²(2·1+2·2)≈1.5 Megabytes. Since these lookup tables would not normally fit within the L1-cache size of most modern CPUs, the access speed to the values in the lookup tables is limited. Thus, the lookup tables may be divided or otherwise reduced in size, such that the size of each lookup table is less than or equal to the size of the L1 cache. In this case, the lookup tables can be stored in the L1 cache of the CPU for faster access.

### 2.9.4. Arctangent Precomputing (AP) Modification

The most time-consuming operations in the gradient computation of subprocess 235 or 435 is a tan 2(·) and, in the case that the l₂ norm is used, the square root operation in the calculation of the l₂ norm. Accordingly, in an embodiment, referred to herein as the arctangent precomputing (AP) modification, these operations in subprocess 235 or 435 are precomputed for a fixed number of angles, and a quantization procedure is applied that approximates the direction of the gradient by one of the fixed number of angles, without computing the angle itself.

Consider the integer solutions of the following equation:

$$\vert x \vert + \vert y \vert = {N}_{a} \qquad Scheme ( 15 )$$

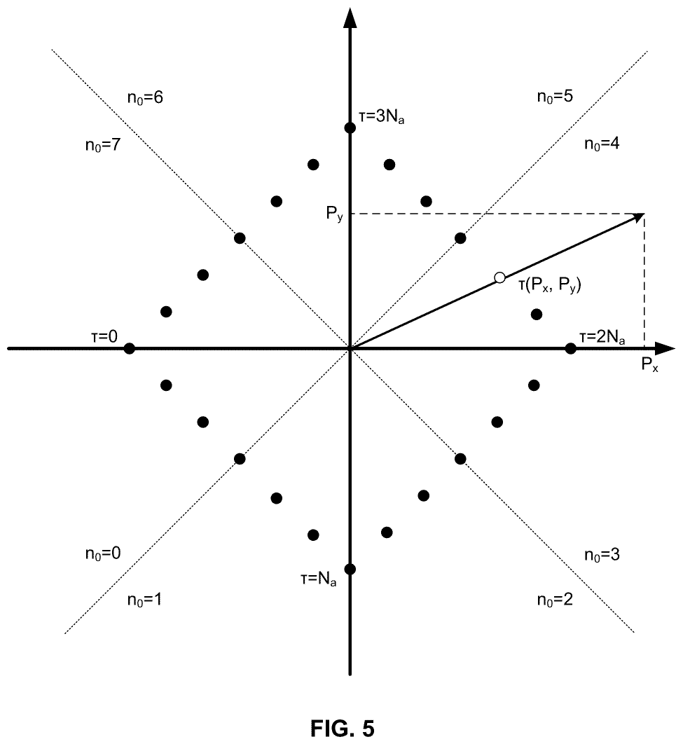

There are 4Nₐ points that satisfy this equation. As illustrated in FIG. 5, when plotted, all of these points lie on a square. They may be numbered with the index τ, counterclockwise, starting with τ=0 for point (−Nₐ, Nₐ).

For a given gradient vector (Pₓ, P_{y}), there is a vector (\hat{P}ₓ, \hat{P}_{y}) that satisfies Scheme (15) and has a minimum angle with (Pₓ, P_{y}). The index of vector (\hat{P}ₓ, \hat{P}_{y}) is denoted as τ(Pₓ, P_{y}), and can be computed with integer-only arithmetic operations:

$$l = \vert {P}_{x} \vert + \vert {P}_{y} \vert \\ {τ}_{0} = ⌊ \frac{{N}_{a} ( {P}_{x} + l ) + l / 2}{l} ⌋ \\ τ = \{ \begin{matrix}{τ}_{0} & if {P}_{y} < 0 or {τ}_{0} = 0 \\ 4 {N}_{a} - {τ}_{0} & otherwise\end{matrix} \qquad Scheme ( 16 )$$

The angles Θ can be computed for all of the points in Scheme (15). These angles are denoted as \hat{Θ}(τ)=a tan 2(\hat{P}ₓ, \hat{P}_{y}). Then, Scheme (5) can be approximated as:

$$Θ ( x , y ) \approx \hat{Θ} ( τ ( ( {P}_{x} ( x , y ) , {P}_{y} ( x , y ) ) ) \qquad Scheme ( 17 )$$

In addition, Scheme (6) can be approximated as:

$$M ( x , y ) = {P}_{x} cos ( Θ ) + {P}_{y} sin ( Θ ) \approx {P}_{x} cos ( \hat{Θ} ) + {P}_{y} sin ( \hat{Θ} ) \qquad Scheme ( 18 )$$

wherein \hat{Θ} is an approximation of Θ, according to Scheme (17). For all 4Nₐ points of the square in Scheme (15), the values of \hat{Θ}, cos(\hat{Θ}), and sin(\hat{Θ}) can all be precomputed.

In the AP modification, the most time-consuming functions from the computation of gradient maps in subprocess 235 or 435 are eliminated, using the above approximations and precomputations. In a further embodiment, all floating-point operations are eliminated. To do this, it is noted that in Scheme (8), n₀, n₁, and w₁ are determined solely by angle Θ. Thus, in addition to \hat{Θ}, cos(\hat{Θ}), and sin(\hat{Θ}), one or more, including potentially all, of the following can also be precomputed:
the indices of gradient maps n₀ (τ) and n₁(τ), as 8-bit values;
the coefficient ŵ₁ (τ)=└w₁(\hat{Θ}(τ))*N_{q})└, as an unsigned 16-bit value; and/or
in the case that the l₂ norm is used, the coefficients cₓ(τ)=└ cos(\hat{Θ}(τ))*N_{q})┘ and c_{y}(τ)=└ sin(\hat{Θ}(τ))*N_{q})┘, as signed 32-bit values.
   In the above, N_{q} is a predefined integer quantization factor.

If the l₂ norm is used, the magnitude of the gradient for the l₂ norm can then also be precomputed as:

$$M ⌊ \frac{{c}_{x} ( τ ) {P}_{x} + {c}_{y} ( τ ) {P}_{y} + {N}_{q} / 2}{{N}_{q}} ⌋ \qquad Scheme ( 19 )$$

If, instead, the l₁ norm is used, the magnitude of the gradient for the l₁ norm has already been computed in Scheme (16):

$$M = l = \vert {P}_{x} \vert + \vert {P}_{y} \vert$$

With all of these precomputations, the values for the gradient maps would be computed in subprocess 235 or 435 as:

$${F}_{{n}_{1}} = ⌊ \frac{{\hat{w}}_{1} ( τ ) M + {N}_{q} / 2}{{N}_{q}} ⌋ \\ {F}_{{n}_{0}} = M - {F}_{{n}_{1}} ( x , y ) \qquad Scheme ( 20 )$$

In an embodiment, the value of N_{q} is a power of two, such that the division in Schemes (19) and (20) can be, and is, replaced with a bit-shift. This bit-shift is more computationally efficient than regular division.

This AP modification provides the fast, integer-only computation of gradient maps in subprocess 235 or 435. In an embodiment, similar to the FP modification, the AP modification utilizes lookup tables. However, the lookup tables used by the AP modification are smaller than in the FP modification. In particular, the lookup tables may comprise three lookup tables of 4Nₐ values in the case that the l₁ norm is used, and an additional two lookup tables of the same size in the case that the l₂ norm is used.

The values of Nₐ and N_{q} are hyperparameters of process 200-400. The bigger that these values are, the more accurately the AP modification approximates the baseline algorithm (i.e., Algorithm 2). However, an increase in the value of Nₐ also increases the sizes of the lookup tables, which may decrease the computational efficiency. The value of N_{q} should be small enough that an overflow of integer values does not occur in Schemes (19) and (20). In addition, as mentioned above, the value of N_{q} should be a power of two, such that division operations can be replaced with simpler and more computationally efficient bit-shift operations.

### 2.9.5. Inequivalence

Notably, the baseline algorithm and each of the above modifications is a modification to the same algorithm for computing RFD-like descriptors. However, out of these five versions, only the baseline algorithm and the FP modification are completely equivalent. In this context, equivalency means that two algorithms are guaranteed to produce the same descriptors, given the same inputs and hyperparameters. Conversely, inequivalence means that two algorithms are not guaranteed to produce the same descriptors, given the same inputs and hyperparameters.

The GS modification applies global smoothing to the input image, and then extracts image patches from the smoothed input image. This means that the values of pixels near the borders of an image patch can be affected by values outside of that image patch. This may result in different gradients and gradient maps than the baseline algorithm, which may lead to different descriptors than the baseline algorithm. However, this effect is not strong.

The GM modification also applies global smoothing, and therefore, is also inequivalent to the baseline algorithm. However, the GM modification is also inequivalent to the GS modification. As demonstrated by Scheme (4), the partial derivatives are not defined on the borders of the image patch (i.e., the left and right columns for Pₓ, and the top and bottoms rows for P_{y}), and may also be set to zero or initialized using the nearest neighbor pixel. The GM modification has no such problem. In the GM modification, the gradient is computed using the values of the input image lying outside the image patches. While this can vary the value of a descriptor, relative to the baseline algorithm or GS modification, the effect is insignificant.

The AP modification is an approximation of the baseline algorithm. Thus, the AP modification is not precise. As the values of N_{q} and Nₐ increase, the inequivalence between the two algorithms will decrease, such that the descriptors become more similar.

Importantly, although the five versions of the algorithm may produce different descriptors, they all produce RFD-like descriptors. Thus, any of the versions, including combinations of two or more versions, may be used for feature-based matching. Moreover, the same receptive fields and thresholds can be used in any version of the algorithm, without loss of quality in image matching. In other words, the receptive fields and thresholds only need to be trained for a single version of the algorithm, to be used across all versions of the algorithm. This is demonstrated in the experimental results below.

### 2.9.6. Parallelism

Most modern CPUs support multi-threading. Consequently, parallel computations have become standard for high-performance applications.

In the algorithms described herein (e.g., processes 200, 300, 400, Algorithm 2, etc.), it is easy to use parallel computations of descriptors. This is because the image patches are processed separately from each other, and do not use common memory, except for the memory that stores input image I as a common source. In the GS and GM modifications, the rows of the globally smoothed input image, the partial derivatives, and the gradient maps can all be computed in parallel.

The importance of parallel computation is the primary reason why the preferred embodiment of the GM modification does not exclude computations of the gradient maps outside of the image patches. Such exclusion would require either the sequential processing of the image patches, or accurate synchronization to prevent data races.

### 2.10. Four Orientations of a Descriptor

Ref3 proposed using RFD descriptors in the localization and classification of identity documents. The position of the identity document was estimated before keypoint extraction, based on segments of straight lines that can be found in the identity document. This allows for the compensation of projective distortion, with the exception of scale and 90-degree rotations. Then, standard feature-based image matching was used to determine the document type and validate the estimated transformation. A disadvantage of this technique is that feature-based image matching should be performed for four possible rotations of the identity document by 0 degrees, 90 degrees, 180 degrees, and 270 degrees.

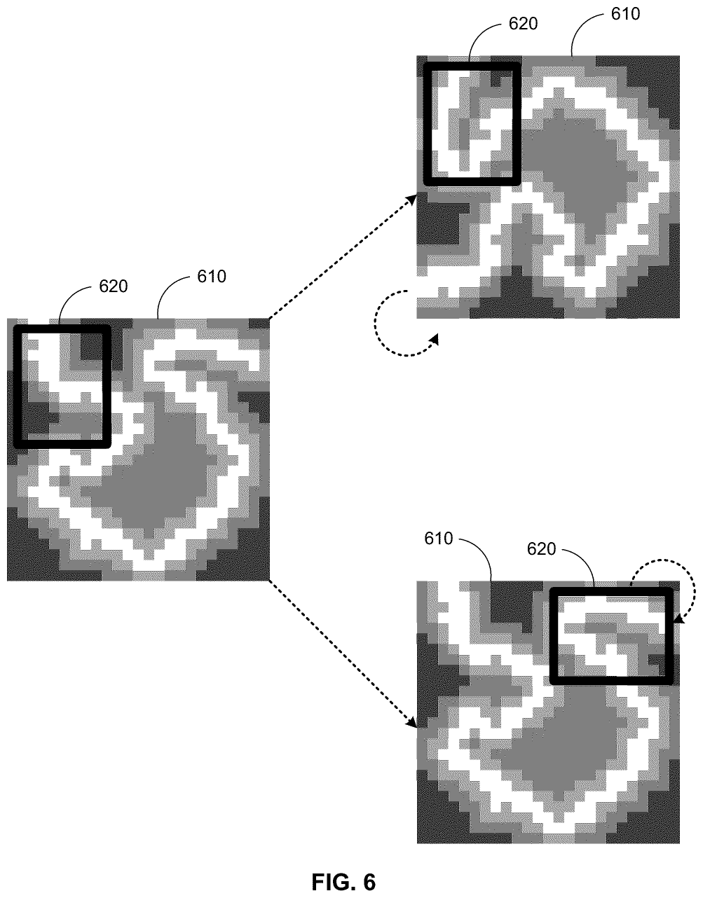

In other words, there is a practical requirement for RFD-like descriptors to compute the descriptor in each of these four orientations. However, advantageously, in the embodiments described herein, there is no need to rotate the image patch to compute the local feature descriptor for that image patch at each of the four orientations. Instead, the receptive fields can be “rotated” into the required orientations. As illustrated in an example in FIG. 6, the result of rotating an image patch 610 is equivalent to rotating the receptive field 620.

In particular, in an embodiment, the following transformation is applied to compute the receptive field for a rotated image patch, without rotating the image patch:

$${c}_{1} = ( {c}_{0} + 2 ) mod 8 \\ {x}_{1} = s - ( {h}_{0} + {y}_{0} ) \\ {y}_{1} = {x}_{0} \\ {w}_{1} = {h}_{0} \\ {h}_{1} = {w}_{0} \qquad Scheme ( 21 )$$

wherein γ₀=(R(x₀, y₀, w₀, h₀), c₀) is a receptive field in the coordinates of the source image patch, and γ₁=(R(x₁, y₁, w₁, h₁), c₁) is the same receptive field in the coordinates of the source image patch, but where the image patch is rotated clockwise by 90 degrees. The size of the image patch is s×s. In addition, the index c of the gradient map is changed, because, when the image patch is rotated, the direction of the gradients is also rotated. Since one gradient map corresponds to 45 degrees in the gradient angle space, the index c of the gradient map is incremented by 2.

Given a set of receptive fields for an RFD-like descriptor, Scheme (21) can be applied three times, sequentially, to compute the sets of receptive fields corresponding to the four orientations (i.e., 0 degrees, 90 degrees, 180 degrees, and 270 degrees) of the image patch. For each image patch, the gradient maps and magnitudes only need to be computed once (e.g., in subprocess 235 or 435), and then, the four sets of receptive fields can be applied (e.g., in subprocess 245) to produce four descriptors, each corresponding to one of the four orientations, for each image patch (e.g., in subprocess 260). This is significantly faster than individually computing the descriptors for each of the four orientations.

### 3. Experimental Results

To measure the computational efficiency and quality of the disclosed embodiments, implementations of the disclosed embodiments were tested in feature-based document localization and classification on the “photos” subset of the Mobile Identity Document Video (MIDV)-2020 dataset (see Ref22). This subset consists of 1,000 images of unique mock identity documents, with 100 images of each of 10 types of identity documents. Each image includes unique text field values and unique artificially generated faces. All images were captured by the camera of a smartphone in challenging conditions, including complicated backgrounds (e.g., keyboard, text, or outdoor scenes), low lighting, high projective distortions, and/or the like.

There were two objectives to the testing: (i) locate the document in the image; and (ii) classify the document in the image. Since there were 10 types of documents, there were 10 classes in the classification task. The location of the document was determined by its quadrangle, since all of the documents were planar rectangles. The images introduced projective distortions to these quadrangles.

The present disclosure is focused on the computation of descriptors. However, to evaluate the descriptor algorithms in terms of computational efficiency and quality, the descriptor algorithm was incorporated into a basic image-matching algorithm. This image-matching algorithm comprised the following steps:
(1) Convert an input red-green-blue (RGB) image to a gray-scale image.
(2) Construct a three-layer scale pyramid, in which the first layer is the gray-scale image, the second layer is the gray-scale image at two-thirds the scale, and the third layer is the gray-scale image at one-half the scale.
(3) For each layer of the scale pyramid, extract keypoints using the Yet Another Contrast-Invariant Point Extractor (YACIPE) (see Ref34). If the number of keypoints is more than Tₖₚ, then select the Tₖₚ keypoints with the highest scores and discard the remaining keypoints.
(4) Compute RFD-like descriptors using one of the embodiments of the algorithms described herein. In the experiments, 128-bit descriptors of 32×32 patches were used, with receptive fields and thresholds selected according to the RFDoc training algorithm (see Ref21).
(5) Calculate the Hamming distance between all local feature descriptors of the input image and the local feature descriptors of ten document templates. If the calculated Hamming distance Dₕ between the input image and a template is less than Tₕ (e.g., Tₕ=32), then there is a match between the image and the template. Otherwise, if the calculated Hamming distance Dₕ between the input image and a template is greater than or equal to Tₕ, then there is no match between the image and the template.
(6) Estimate the projective transformation H, which maps a region of the input image to coordinates in the matched template, using RANSAC on the matching keypoints. The sampling probability of a pair of keypoints is set to pₛ=(Tₕ−Dₕ)/Tₕ, so that pairs of keypoints that are more likely to match are more likely to be selected in RANSAC. 10⁶ iterations were used in the main loop of RANSAC, and the results were fine-tuned. As in Ref3, close points were not selected in the RANSAC hypothesis.

The projective transformation H is the answer to the image-matching algorithm. Notably, in a practical image-matching algorithm, the limit on the number of keypoints is significantly smaller than Tₖₚ, and the limit on the number of RANSAC iterations is significantly smaller than 10⁶. For example in Ref3, Tₖₚ=1500, and there are 8,000 RANSAC iterations. However, the focus of the experimentation is on the descriptor computation. Thus, the value of Tₖₚ was increased to investigate the dependence of computational efficiency on the number of keypoints, and the number of RANSAC iterations was set high to reduce the influence of the transformation estimation stage on the quality of the image matching. The Hamming distance was directly computed between all descriptor pairs to achieve reproducible results, as suggested in Ref21.

To match the input image to a template image, the descriptors of the keypoints of the document template were computed in advance. Since there were ten types of documents, ten templates were used, with one template for each type of document. Only keypoints that lie in the static regions of documents (i.e., regions that do not contain personal data) were used, as suggested in Ref3.

Notably, the above image-matching algorithm is not the best for document localization and classification. Image-matching algorithms that combine local and global features of images produce better quality results than those that rely solely on local features (see Ref4). However, a basic feature-based image-matching algorithm was used for experimentation, in order to study local feature descriptors.

The main characteristic that was estimated during experimentation was the computational efficiency of computing RFD-like descriptors on CPUs. Embodiments of the descriptor algorithm, described herein, were run using AMD Ryzen 9 5950X and Amlogic S922X Cortex-A53 CPUs. The AMD CPU had an x86_64 architecture, which is common for desktop personal computers, and will be denoted herein as x86. The Amlogic CPU had an Advanced Reduced Instruction Set Computer (RISC) Machine (ARM) architecture, and will be denoted herein as ARM.

The quality of feature-based document localization and classification, using disclosed embodiments to compute descriptors, was also measured. Since classification was a simple ten-class classification, the rate of correctly classified documents (i.e., accuracy) was used to measure the quality. In document localization, the task is to estimate the projective transformation M that maps the document quadrangle m on the input image to the template rectangle t. In other words, t=M(m). Let H denote the estimated projective transformation and q denote the estimated quadrangle: q=H⁻¹(t). As in Ref22, the following scores measure the localization quality:

$$IoU ( q , m , t ) = \frac{area ( M ( q ) ⋂ t )}{area ( M ( q ) t )} \qquad Equation ( 22 )$$

$$D ( q , m , t ) = {max}_{u} \frac{{‖ {t}_{i} - H ( {m}_{i} ) ‖}_{2}}{P ( t )} \qquad Equation ( 23 )$$

wherein P(t) is the perimeter of the template rectangle t. Equation (22) computes the intersection-over-union score in the coordinates of template rectangle t. Equation (23) computes the normalized maximum distance between corresponding vertices in the coordinates of the estimated quadrangle q.

The running times of the baseline algorithm, GS modification, GM modification, FP modification, and AP modification were experimentally compared for the RFD-like descriptor computations. In particular, the image-matching algorithm above was run in a single thread of the x86 and ARM CPUs, and the time required by the descriptor computations was measured. It should be understood that the descriptor computation time will vary between images, since different images will have different numbers of keypoints.

The dependency of the descriptor computation time on the number of keypoints was linear for the baseline algorithm, FP modification, and AP modification. This is because the number of keypoints equals the number of image patches in these algorithms. The GS modification and the GM modification require some time per computation stage, and after that, the dependence becomes linear.

The compare the computational efficiency of the algorithms, the mean time (Tₘ) of the descriptor computation per image and the estimated time (Tₑ), using linear estimation via mean squared error (MSE), for 1500 keypoints were computed. Table 2 below depicts the results:

TABLE 2

| | | x86 | | ARM | |
|---|---|---|---|---|---|
| | | Tₘ | Tₑ | Tₑ | Tₘ |
| Algorithm | Norm | (seconds) | (seconds) | (seconds) | (seconds) |
| Baseline | l₁ | 0.177 | 0.036 | 1.80 | 0.17 |
| GS | | 0.182 | 0.067 | 1.70 | 0.28 |
| GM | | 0.454 | 0.450 | 1.80 | 1.17 |
| AP | | 0.068 | 0.014 | 0.91 | 0.09 |
| FP | | 0.067 | 0.014 | 0.91 | 0.09 |
| Baseline | l₂ | 0.184 | 0.038 | 1.87 | 0.18 |
| GS | | 0.190 | 0.069 | 1.77 | 0.28 |
| GM | | 0.483 | 0.487 | 1.89 | 1.27 |
| AP | | 0.075 | 0.016 | 1.03 | 0.10 |
| FP | | 0.068 | 0.014 | 0.91 | 0.09 |

These metrics demonstrate that precomputation significantly accelerates the computation of RFD-like descriptors. The FP modification is two times faster than the baseline algorithm on the ARM CPU, and 2.6 times faster than the baseline algorithm on the x86 CPU. The AP modification demonstrates the same computational efficiency as the FP modification for the l₁ norm, and is about 10% slower than the FP modification for the l₂ norm. The algorithms with global precomputation stages (i.e., the GS and GM modifications) only show better computation efficiency when the number of image patches is sufficiently high. When the number of image patches is low, resulting in fewer intersections, the AP modification, FP modification, and baseline algorithm are superior to the GS and GM modifications.

In most cases, the best algorithm to use for descriptor computation is the FP modification. The FP modification is easy to implement and shows the best computational efficiency. However, if the l₁ norm is used to compute the gradient maps, the AP modification demonstrates the same computational efficiency, while using significantly less memory. In tasks with a very high number of keypoints, such that the total area of the image patches is comparable to the area of the entire input image, the GS and GM algorithms may be used. Moreover, the global smoothing of the GS modification can be combined with the fast gradient-map computations of the FP modification.

As disclosed above, embodiments may compute the RFD-like descriptors for the four orientations of an image patch simultaneously, rather than one by one. The time to compute an RFD-like descriptor in a single orientation is denoted t₁, and the time to simultaneously compute RFD-like descriptors for all four orientations is denoted t₄. Embodiments that simultaneously compute RFD-like descriptors will be 4t₁/t₄ times faster than embodiments which compute the RFD-like descriptors for each orientation one by one. Table 3 below depicts this metric for the AP modification and the FP modification:

TABLE 3

| Algorithm | Norm | x86 | ARM |
|---|---|---|---|
| AP | l₁ | 2.84 | 3.33 |
| FP | | 2.82 | 3.32 |
| AP | l₂ | 2.93 | 3.40 |
| FP | | 2.82 | 3.32 |

As demonstrated in Table 3, simultaneous computation of the RFD-like descriptors for all four orientations is approximately 3 times faster than simply rotating the input image three times to recompute the descriptor for each orientation.

As discussed above, the baseline algorithm, GS modification, GM modification, FP modification, and AP modification are not all equivalent to each other. Thus, experiments were implemented to evaluate whether the choice of algorithm affects the quality of image matching. In particular, each of the five algorithms are evaluated on the “photos” subset of the MIDV-2020 dataset, as described above. The receptive fields and thresholds of the RFD-like descriptors were computed in advance, as described in Ref21. For each algorithm, only the descriptors of the keypoints of the templates were recomputed before image matching.

To solve the image-classification task (i.e., ten-class classification), the template with the greatest number of inliers of the RANSAC (i.e., the keypoint pairs that satisfy the estimated transformation) was selected. To evaluate the localization quality, the IoU (see Ref22) and D (see Ref23) were computed and compared to thresholds 0.9 and 0.2, respectively, as in Ref22. Table 4 depicts the results:

TABLE 4

| Algorithm | Accuracy (%) | D < 0.02 (%) | IoU > 0.09 (%) |
|---|---|---|---|
| Baseline | 91.1 | 79.9 | 81.2 |
| GS | 91.3 | 80.7 | 81.6 |
| GM | 92.4 | 80.3 | 81.1 |
| AP | 91.5 | 80.3 | 80.9 |
| FP | 91.1 | 79.9 | 81.2 |

As demonstrated in Table 4, all of the disclosed descriptor algorithms demonstrate similar quality on the image-matching task. The observed differences in qualities are inconsistent over the metrics and insignificant, considering that there were only 1,000 images in the dataset. This means that any of the descriptor algorithms can be used, and that there is no need to recompute the receptive fields and thresholds for each descriptor algorithm.

### 4. INDUSTRIAL APPLICABILITY

Binary RFD-like descriptors have been designed to be fast and demonstrate good quality in image-matching tasks. RFDoc is one such descriptor that demonstrates state-of-the art results in document localization. However, the computational efficiency of such descriptors greatly depends on their implementations.

Disclosed embodiments may compute RFD-like descriptors (e.g., for 8-bit single-channel images), using one or more of the GS, GM, FP, and AP modifications to address identified weak points in the baseline algorithm. The embodiments may utilize one or both of two mechanisms for accelerating the descriptor computations: (i) compute common operations globally for the entire input image, instead of computing those operations locally for every image patch; and/or (ii) use lookup tables to replace the most computationally demanding operations and minimize the number of conversions between integer and floating-point data types.

Experiments, utilizing the disclosed embodiments for document localization and classifications, demonstrate that the modifications with lookup tables are significantly faster than the baseline algorithm (e.g., by 2.0 to 2.6 times on x86 and ARM CPUs). In particular, the FP modification precomputes all possible values of the discrete gradient and is easy to implement, and the AP modification precomputes coefficients for quantized angles of the gradient and is more memory-efficient. In addition, modifications with global operations (e.g., smoothing and gradient-map computation) may be more computationally efficient than the baseline algorithm when there are many intersecting image patches (e.g., the total area of image patches is comparable to the area of the entire input image) that require descriptor computation. The experiments also demonstrated that any of the proposed modifications can be used without loss of image-matching quality and without the need to retrain the parameters (e.g., receptive fields and thresholds) of the RFD-like descriptors.

An efficient way to simultaneously compute RFD-like descriptors for four orientations of an image patch has also been disclosed. This is an important task for document localization. The disclosed embodiment reduces the four runs for all four orientations into a single run. In other words, the four descriptors for a given image patch can be computed three times faster, as demonstrated by the experiments.

### 5. REFERENCES

The present disclosure may refer to the following references, which are all hereby incorporated herein by reference as if set forth in their entireties:
Ref1: Gao et al., “Local feature performance evaluation for structure-from-motion and multi-view stereo using simulated city-scale aerial imagery,” The Institute of Electrical and Electronics Engineers (IEEE) Sensors Journal, vol. 21, no. 10, pp. 11615-11627, 2020;
Ref2: Gauglitz et al., “Evaluation of interest point detectors and feature descriptors for visual tracking,” International Journal of Computer Vision, vol. 94, no. 3, pp. 335-360, 2011;
Ref3: Skoryukina et al., “Fast method of id documents location and type identification for mobile and server application,” in International Conference on Document Analysis and Recognition (ICDAR) 2019, Manhattan, New York, USA, IEEE, February 2020, pp. 850-857, dOI: 10.1109/ICDAR.2019.00141;
Ref4: Skoryukina et al., “Memory consumption reduction for identity document classification with local and global features combination,” in International Conference on Machine Vision (ICMV) 2020, vol. 11605, no. 116051G, Bellingham, Washington 98227-0010, USA, Society of Photo-Optical Instrumentation Engineers (SPIE), January 2021, pp. 116 051G1-116 051G8, dOI: 10.1117/12.2587033;
Ref5: Ma et al., “Image matching from hand-crafted to deep features: A survey,” International Journal of Computer Vision, vol. 129, no. 1, pp. 23-79, 2021;
Ref6: Lowe, “Distinctive image features from scale-invariant keypoints,” International Journal of Computer Vision, vol. 60, no. 2, pp. 91-110, 2004;
Ref7: Bay et al., “Speeded-Up Robust Features (SURF),” Computer Vision and Image Understanding, vol. 110, no. 3, pp. 346-359, 2008;
Ref8: Ojala et al., “Multiresolution gray-scale and rotation invariant texture classification with local binary patterns,” IEEE Transactions on Pattern Analysis and Machine Intelligence, vol. 24, no. 7, pp. 971-987, 2002;
Ref9: Tola et al., “DAISY: An efficient dense descriptor applied to wide-baseline stereo,” IEEE Transactions on Pattern Analysis and Machine Intelligence, vol. 32, no. 5, pp. 815-830, 2009;
Ref10: Wang et al., “Exploring local and overall ordinal information for robust feature description,” IEEE Transactions on Pattern Analysis and Machine Intelligence, vol. 38, no. 11, pp. 2198-2211, 2015;
Ref11: Calonder et al., “BRIEF: Binary Robust Independent Elementary Features,” in European Conference on Computer Vision, Springer, 2010, pp. 778-792;
Ref12: Rublee et al., “ORB: An efficient alternative to SIFT or SURF,” in 2011 International Conference on Computer Vision, IEEE, 2011, pp. 2564-2571;
Ref13: Norouzi et al., “Fast exact search in hamming space with multi-index hashing,” IEEE Transactions on Pattern Analysis and Machine Intelligence, vol. 36, no. 6, pp. 1107-1119, 2013;
Ref14: Leng et al., “Local feature descriptor for image matching: A survey,” IEEE Access, vol. 7, pp. 6424-6434, 2018;
Ref15: Ke et al., “PCA-SIFT: A more distinctive representation for local image descriptors,” in Proceedings of the 2004 IEEE Computer Society Conference on Computer Vision and Pattern Recognition (CVPR) 2004, vol. 2, IEEE, 2004, pp. II-II;
Ref16: Balntas et al., “Learning local feature descriptors with triplets and shallow convolutional neural networks,” in British Machine Vision Conference (BMVC), vol. 1, no. 2, 2016, p. 3;
Ref17: Mishchuk et al., “Working hard to know your neighbor's margins: Local descriptor learning loss,” Advances in Neural Information Processing Systems, vol. 30, 2017;
Ref18: Trzcinski et al., “Learning image descriptors with the boosting-trick,” Advances in Neural Information Processing Systems, vol. 25, 2012;
Ref19: Trzcinski et al., “Boosting binary keypoint descriptors,” in Proceedings of the IEEE Conference on Computer Vision and Pattern Recognition, 2013, pp. 2874-2881;
Ref20: Fan et al., “Receptive fields selection for binary feature description,” IEEE Transactions on Image Processing, vol. 23, no. 6, pp. 2583-2595, 2014;
Ref21: Matalov et al., “RFDoc: memory efficient local descriptors for id documents localization and classification,” in International Conference on Document Analysis and Recognition (ICDAR) 2021, ser. Lecture Notes in Computer Science (LNCS), Lladós et al., Eds., vol. 12822, London, UK (main office): Springer Nature Group, Sen. 2021, pp. 209-224, dOI: 10.1007/978-3-030-86331-9_14;
Ref22: Bulatov et al., “MIDV-2020: A comprehensive benchmark dataset for identity document analysis,” Computer Optics, vol. 46, no. 2, pp. 252-270, 2022, dOI: 10.18287/2412-6179—CO-1006;
Ref23: Adelson et al., “Pyramid methods in image processing,” RCA Engineer, vol. 29, no. 6, pp. 33-41, 1984;
Ref24: Viola et al., “Rapid object detection using a boosted cascade of simple features,” in Proceedings of the 2001 IEEE Computer Society Conference on Computer Vision and Pattern Recognition (CVPR), 2001, vol. 1, IEEE, 2001, pp. I-I;
Ref25: Tuzel et al., “Region covariance: A fast descriptor for detection and classification,” in European Conference on Computer Vision, Springer, 2006, pp. 589-600;
Ref26: Arlazarov et al., “On economical construction of the transitive closure of an oriented graph,” in Doklady Akademii Nauk, vol. 194, no. 3, Russian Academy of Sciences, 1970, pp. 487-488;
Ref27: Ambai et al., “Card: Compact and real-time descriptors,” in 2011 International Conference on Computer Vision, IEEE, 2011, pp. 97-104;
Ref28: Hwang et al., “Local descriptor by Zernike moments for real-time keypoint matching,” in 2008 Congress on Image and Signal Processing, vol. 2, IEEE, 2008, pp. 781-785;
Ref29: Rosten et al., “Machine learning for high-speed corner detection,” in European Conference on Computer Vision, Springer, 2006, pp. 430-443;
Ref30: Viswanath et al., “Orb in 5 ms: An efficient SIMD friendly implementation,” in Asian Conference on Computer Vision, Springer, 2014, pp. 675-686;
Ref31: Suárez et al., “BEBLID: Boosted Efficient Binary Local Image Descriptor,” Pattern Recognition Letters, vol. 133, pp. 366-372, 2020;
Ref32: He et al., “Local descriptors optimized for average precision,” in Proceedings of the IEEE Conference on Computer Vision and Pattern Recognition, 2018, pp. 596-605.
Ref33: Gholami et al., “A survey of quantization methods for efficient neural network inference,” ar Xiv preprint arXiv:2103.13630, 2021;
Ref34: Lukoyanov et al., “Modification of YAPE keypoint detection algorithm for wide local contrast range images,” in International Conference on Machine Vision 2017, Verikas et al., Eds., vol. 10696, Bellingham, Washington 98227-0010 USA: Society of Photo-Optical Instrumentation Engineers (SPIE), April 2018, pp. 1 069 616-1-1 069 616-8, dOI: 10.1117/12.2310243; and
Ref35: Gonzalez et al., Digital Image Processing (3rd Edition), USA: Prentice-Hall, Inc., 2006.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
precompute all possible integer values of partial derivatives of image pixels in an input image, the image pixels having a predetermined bit depth;
for each of the precomputed integer values of partial derivatives, precompute integer values of gradient maps for at least a portion of the input image, and store the precomputed integer values of gradient maps in one or more lookup tables, indexed by the precomputed integer values of partial derivatives;
compute local feature descriptors for a plurality of keypoints on the input image by
computing the partial derivatives of the image pixels from the input image,
determining gradient maps for each of the plurality of keypoints by performing lookups in the one or more lookup tables using the computed partial derivatives as an index without directly computing the gradient maps from the computed partial derivatives, and
generating the local feature descriptor for each of the plurality of keypoints based on the gradient maps; and
output an image descriptor of the input image, wherein the image descriptor comprises the computed local feature descriptors for the plurality of keypoints.

2. The method of claim 1, wherein computing the local feature descriptors comprises, for each of the plurality of keypoints:
extracting an image patch from the input image, wherein the image patch encompasses the keypoint;
smoothing the image patch; and
computing the partial derivatives of the image pixels from the smoothed image patch.

3. The method of claim 2, wherein the input image comprises a scale pyramid comprising an image at a plurality of scales, and wherein extracting an image patch comprises extracting an image patch from the image in the scale pyramid that is at one of the plurality of scales that corresponds to a scale of the keypoint.

4. The method of claim 2, wherein smoothing the image patch comprises applying a Gaussian filter to the image patch.

5. The method of claim 1, further comprising using the at least one hardware processor to smooth the input image prior to computing the local feature descriptors, wherein computing the local feature descriptors comprises, for each of the plurality of keypoints:
extracting an image patch, corresponding to the keypoint, from the smoothed input image; and
computing the partial derivatives of the image pixels from the image patch.

6. The method of claim 5, wherein the input image comprises a scale pyramid comprising an image at a plurality of scales, and wherein extracting an image patch comprises extracting an image patch from the image in the scale pyramid that is at one of the plurality of scales that corresponds to a scale of the keypoint.

7. The method of claim 5, wherein smoothing the input image comprises applying a Gaussian filter to the input image.

8. The method of claim 1, wherein the at least a portion of the input image is an entirety of the input image.

9. The method of claim 1, wherein the at least a portion of the input image consists of only regions of the input image that correspond to image patches for the plurality of keypoints.

10. The method of claim 1, wherein the gradient maps are determined according to
$$ϕ = \frac{4 ( Θ ( x , y ) + π )}{π} \\ {w}_{1} = ϕ - ⌊ ϕ ⌋ \\ {n}_{0} = ⌊ ϕ ⌋ mod 8 \\ {n}_{1} = ( {n}_{0} + 1 ) mod 8 \\ {F}_{{n}_{1}} ( x , y ) = [ {w}_{1} M ( x , y ) ] \\ {F}_{{n}_{0}} ( x , y ) = M ( x , y ) - {F}_{{n}_{1}} ( x , y ) \\ {F}_{i ; i ∈ \{ 0 , … , 7 \} \backslash \{ {n}_{0} , {n}_{1} \}} = 0$$
wherein x, y are coordinates in the input image, Θ is a gradient orientation, M is a gradient magnitude that is a function of the partial derivatives, └·┘ denotes rounding down, and [·] denotes rounding to the nearest integer, wherein the precomputed integer values of the gradient maps comprise n₀, n₁, Fₙ_{₀}, and Fₙ_{₁}, and wherein, during computation of the local feature descriptors, determining the gradient maps comprises looking up these precomputed integer values of the gradient maps in the one or more lookup tables.

11. The method of claim 10, further comprising using the at least one hardware processor to:
prior to computing the local feature descriptors,
precompute values of arctangent for a predetermined number of fixed angles based on the partial derivatives, and
store the precomputed values of arctangent in the one or more lookup tables;
wherein, during computation of the local feature descriptors, determining the gradient maps comprises
quantizing a gradient into one of the fixed angles, and
looking up the precomputed value of arctangent for that one fixed angle.

12. The method of claim 1, wherein generating the local feature descriptor comprises, for each of the plurality of keypoints:
extracting an image patch corresponding to the keypoint; and,
for each of a plurality of rectangular receptive fields in the image patch, determine a response based on the gradient maps for the keypoint.

13. The method of claim 12, wherein generating the local feature descriptor comprises, for each of the plurality of keypoints, for each of the plurality of rectangular receptive fields in the image patch:
binarize the response to produce a binary value; and
store the binary value in a vector representing the local feature descriptor.

14. The method of claim 12, wherein determining a response based on the gradient maps for the keypoint comprises determining the response in each of four orientations by rotating the rectangular receptive field three times by 90 degrees, according to:
$${c}_{1} = ( {c}_{0} + 2 ) mod 8 \\ {x}_{1} = s - ( {h}_{0} + {y}_{0} ) \\ {y}_{1} = {x}_{0} \\ {w}_{1} = {h}_{0} \\ {h}_{1} = {w}_{0}$$
wherein x₀, y₀ represent a corner of the rectangular receptive field in a first orientation, w₀ represents a width of the rectangular receptive field in the first orientation, h₀ represents a height of the rectangular receptive field in the first orientation, c₀ represents an index of a gradient map for the first orientation, x₁, y₁ represent a corner of the rectangular receptive field in a second orientation rotated 90 degrees from the first orientation, w₁ represents a width of the rectangular receptive field in the second orientation, h₁ represents a height of the rectangular receptive field in the second orientation, and c₁ represents an index of a gradient map for the second orientation.

15. The method of claim 1, wherein generating the local feature descriptor comprises, for each of the plurality of keypoints:
extracting an image patch corresponding to the keypoint; and,
for each of a plurality of rectangular receptive fields in the image patch,
simultaneously determine a response and binarize the response to produce a binary value b, based on the gradient maps for the keypoint according to
$$b = \{ \begin{matrix}0 , & {\sum }_{x , y ∈ R} {F}_{c} ( x , y ) < t {\sum }_{x , y ∈ R} M ( x , y ) \\ 1 , & otherwise\end{matrix}$$
wherein x, y are coordinates in the image patch, R is a rectangle of the rectangular receptive field, F_{c} is a gradient map of the receptive field at index c, t is a threshold associated with the receptive field, and M is a gradient magnitude, and
store the binary value b in a vector representing the local feature descriptor.

16. The method of claim 15, wherein the gradient magnitude M is calculated as an l₁ norm.

17. The method of claim 15, wherein the gradient magnitude M is calculated as an l₂ norm.

18. A system comprising:
at least one hardware processor; and
one or more software modules that are configured to, when executed by the at least one hardware processor,
precompute all possible integer values of partial derivatives of image pixels in an input image, the image pixels having a predetermined bit depth,
for each of the precomputed integer values of partial derivatives, precompute integer values of gradient maps for at least a portion of the input image, and store the precomputed integer values of gradient maps in one or more lookup tables, indexed by the precomputed integer values of partial derivatives,
compute local feature descriptors for a plurality of keypoints on the input image by
computing the partial derivatives of the image pixels from the input image,
determining gradient maps for each of the plurality of keypoints by performing lookups in the one or more lookup tables using the computed partial derivatives as an index without directly computing the gradient maps from the computed partial derivatives, and
generating the local feature descriptor for each of the plurality of keypoints based on the gradient maps, and
output an image descriptor of the input image, wherein the image descriptor comprises the computed local feature descriptors for the plurality of keypoints.

19. A non-transitory computer-readable medium having instructions stored therein, wherein the instructions, when executed by a processor, cause the processor to:
precompute all possible integer values of partial derivatives of image pixels in an input image, the image pixels having a predetermined bit depth;
for each of the precomputed integer values of partial derivatives, precompute integer values of gradient maps for at least a portion of the input image, and store the precomputed integer values of gradient maps in one or more lookup tables, indexed by the precomputed integer values of partial derivatives;
compute local feature descriptors for a plurality of keypoints on the input image by
computing the partial derivatives of the image pixels from the input image,
determining gradient maps for each of the plurality of keypoints by performing lookups in the one or more lookup tables using the computed partial derivatives as an index without directly computing the gradient maps from the computed partial derivatives, and
generating the local feature descriptor for each of the plurality of keypoints based on the gradient maps; and
output an image descriptor of the input image, wherein the image descriptor comprises the computed local feature descriptors for the plurality of keypoints.
